(19) United States
(12) Patent Application Publication
(10) Pub. No.: US 2004/0000514 A1
(43) Pub. Date: Jan. 1, 2004

(54) Filter/screening disc and process for manufacturing this kind of disc

(76) Inventors: Helmuth Gabl, Graz (AT); Christian Buedenbender, Graz (AT); Peter Sket, Gratkorn (AT)

Correspondence Address: ALIX YALE & RISTAS LLP, 750 MAIN STREET, SUITE 1400, HARTFORD, CT, 06103, US

(21) Appl. No.: 10/459,903

(22) Filed: Jun. 12, 2003

(30) Foreign Application Priority Data
Jun. 19, 2002 (AT) A 920/2002

(51) Int. Cl. B01D 29/41

(52) U.S. Cl. 210/347; 210/486

(57) ABSTRACT

A filter/screening disc for membrane filtration includes a base structure connected to a hollow shaft and to which screening/filter elements are secured. The filter/screening disc is made up of two halves.

### BACKGROUND OF THE INVENTION

This invention relates generally to filter or screening discs for membrane filtration. More particularly, the present invention relates to filter or screening discs for membrane filtration having a base structure connected to a hollow shaft and to which screening or filter elements are secured. It also refers to a process for manufacturing this kind of filter disc.

Filters with filter discs require a large filter area, particularly in membrane filtration. Filters like those described in WO 00/47312, for example, need a large number of filter discs, which are particularly expensive to manufacture in the case of membrane filtration.

### SUMMARY OF THE INVENTION

The aim of the invention is to create a low-cost manufacturing method for this kind of filter disc.

According to the invention, this is achieved by the filter disc being made up of two, preferably identical halves. This measure means that basic parts can be produced very easily and at low cost, and the filter elements can also be mounted easily on the base structure.

A favorable further development of the invention is characterized by the largely identical halves being manufactured using the deep-drawing process, however they can also be made as cast or welded parts as an alternative.

An advantageous configuration of the invention is characterized by the filter disc halves being suitable for interlocking with one another, where the filter discs can have a bayonet catch. As a result, the membrane or screening side on the upper side (filter side) remains undamaged and can be welded to the spacer from the permeate side. On the one hand, the two halves, comprising spacer plate, base structure and filter or screening surface, can be interlocked, while the second possibility is to join the filter or screening surfaces to the base structure.

An advantageous further development of the invention is characterized by the screen or filter element being welded to the base structure, however it can also be fitted with clips and attached to the base element with these clips. Thus, the filter area can remain intact without any substantial impairment or damage.

The invention also relates to a process for manufacturing a filter disc, particularly for membrane filtration, with a hollow base structure that is connected to a hollow shaft and secured to the screening or filter elements. According to the invention, this is characterized by the filter disc being made in two halves.

A favorable further development of the invention is characterized by the halves being manufactured using a welding or deep-drawing process, however they can also be cast. Thus, the most suitable material can be used depending on the application in each case.

An advantageous configuration of the invention is characterized by the halves being interlocked with one another, where the two pieces are sealed with a joining process and secured to prevent the joint being opened up again.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a section through a conventional filter;

FIG. 2 is a horizontal projection of a filter disc according to the invention;

FIG. 3 is a sectional view along the line marked III-III in FIG. 2;

FIG. 4 is a sectional view along the line marked IV-IV in FIG. 3;

FIG. 5 is an enlarged view of area V of FIG. 3;

FIG. 6 is an enlarged sectional view of the hollow shaft and base of FIG. 3 illustrating a first variant for securing the filter element to the hollow shaft; and

FIG. 7a is an enlarged sectional view of the hollow shaft and base of FIG. 3 illustrating a second variant for securing the filter element to the hollow shaft, and

FIG. 7b is a view of FIG. 7a according to the arrow marked VII.

### DETAILED DESCRIPTION OF THE PREFERRED EMBODIMENT

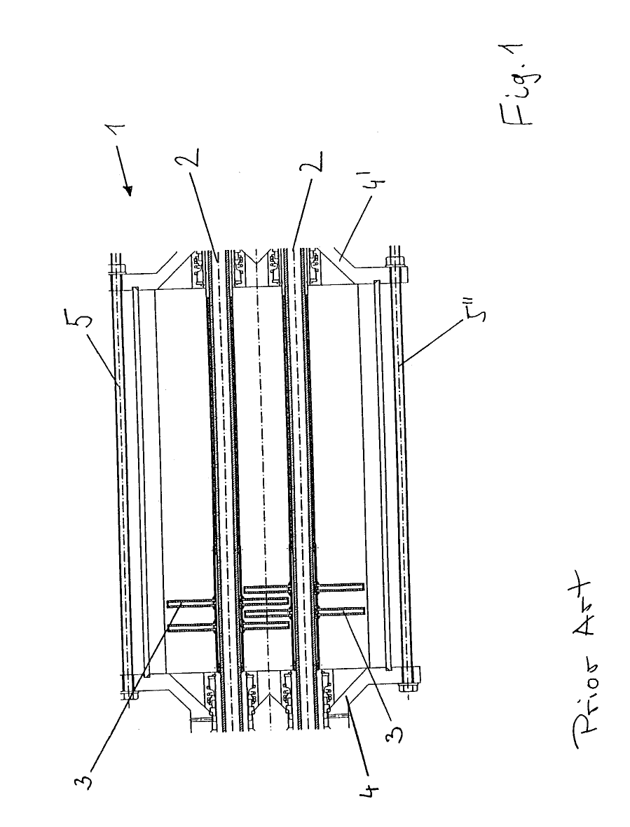

FIG. 1 shows a sectional view through a conventional filter 1, where two hollow shafts 2 are visible. To provide a clearer illustration, two filter discs 3 are shown here on each hollow shaft, although normally there are discs 3 fitted along the entire length of the shaft. This figure shows particularly clearly how the two end sections 4, 4′ have to be held together with several connecting rods 5, 5′.

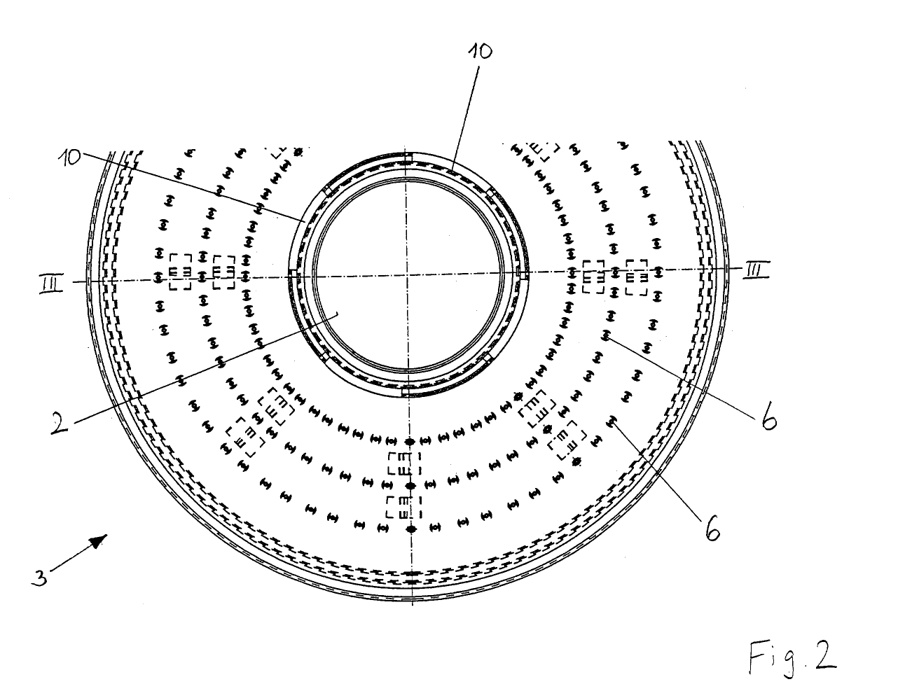

FIG. 2 shows a horizontal projection of a filter or screening disc 3 with a hollow shaft 2, according to the invention. The filter or screening discs 3 can contain filter or screening surfaces of ceramic, metal or other materials, e.g. plastic. Depending on the application, perforations, pores or slot widths from <50 microns to several hundred microns up to approximately 2-5 mm can be used. The diameter of the hollow shaft 2 is selected according to the permeate mass flow, which results in significant differences in diameter when used as a filtration or screening machine. The horizontal projection shows the fastening points 6 (welding points for example) of the filter or screening surface to the base frame of the filter or screening disc 3. In order to allow the permeate to drain off from the filter or screening disc 3 into the hollow shaft 2, several discharge openings 10 are provided round the inner circumference of the filter or screening disc 3.

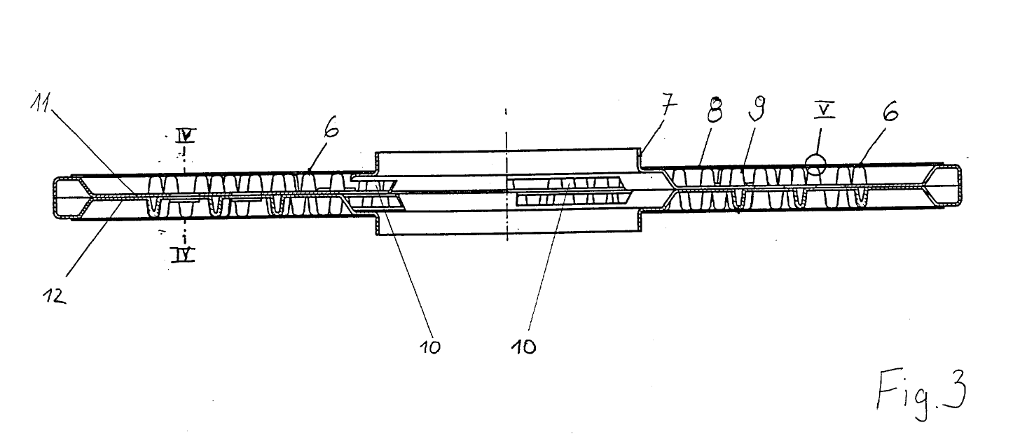

In FIG. 3, a sectional view is provided through the filter disc 3 according to the line marked III-III in FIG. 2. Here, we can see the base frame 7, which can be a deep-drawn, cast or welded structure. The screen or filter element 8 is mounted on this base frame 7 and secured to the base frame using, for example, a conventional welding process (electron-beam welding, laser welding, TIG welding, soldering, etc.). The seam can be formed by spot welding, straight welding or flush welding. It is an advantage to weld from the supporting structure side because this is where there is the least possible damage to the screen or filter area. The base frame 7 must absorb carrying and tensile forces generated by the process (high operating pressure, high permeate resistance, backwashing, etc.). In order to withstand the resulting mechanical, pneumatic and hydraulic stresses, various supports 9 are provided in different forms in the base frame 7 manufactured by deep-drawing, welding or casting. This illustration also shows the discharge openings 10 from the filter or screening disc 3 to the hollow shaft 2.

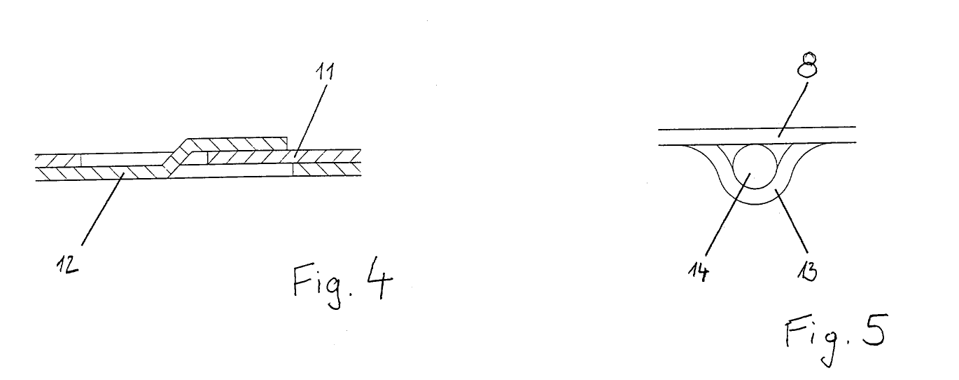

FIG. 4 shows a sectional view along the line marked IV-IV in FIG. 3. This figure illustrates how the two disc halves 11, 12, each including a portion of the spacer plate, base structure and filter/screening surface, are mounted together. This is achieved by placing the two halves 11, 12 one on top of the other and then rotating them through a small angle of approximately 2-5°.

FIG. 5 contains an extract according to the circle marked V in FIG. 3, with clips 13 being mounted at the screening or filter element 8 which protrude into the corresponding rods 14 in the base frame 7. This allows the screening or filter element 8 to be secured easily to the base frame 7.

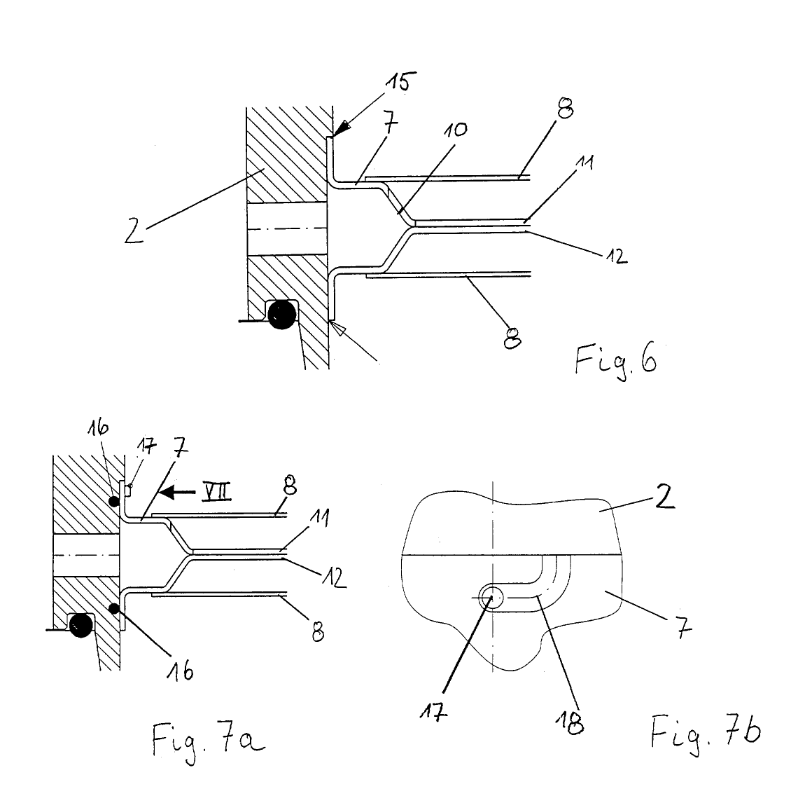

The connection between the filter disc 3 and the hollow shaft 2 is of particular significance because of the mechanical forces to be transferred on the one hand, and because of the filter areas to be sealed off against short-circuit flows on the other hand. This can be achieved as shown in FIG. 6, where the base frame 7 is directly connected in a groove 15 to the hollow shaft 2 using a standard joining process (welding, soldering, gluing, etc.).

Another possibility is shown in FIG. 7a, where a detachable connection is provided between disc element 3 and hollow shaft 2. The base frame 7 fitted with the screening or filter element 8 is sealed off against short-circuit flows by means of seals 16 provided in the hollow shaft. The view in FIG. 7b shows the journal 17 at the hollow shaft 2 and the slot 18 in the base frame 7 that form a bayonet catch for securing the filter disc 3.

While preferred embodiments have been shown and described, various modifications and substitutions may be made thereto without departing from the spirit and scope of the invention. Accordingly, it is to be understood that the present invention has been described by way of illustration and not limitation. For example, a solid central shaft surrounded by an enveloping shaft, with a hollow space between the central shaft and the enveloping shaft, can also be used. The filter or screening shafts are then secured to the enveloping shaft and the permeate is carried off between enveloping shaft and central shaft.

What is claimed is:

1. Filter/screening disc for use with a membrane filter including a hollow shaft, the filter/screening disc comprising:
a base structure adapted for connection to the hollow shaft and
a screen/filter element secured to the base structure;
wherein the filter/screening disc comprises first and second disc halves.

2. Filter/screening disc according to claim 1, wherein the disc halves are manufactured using a deep-drawing or welding process.

3. Filter/screening disc according to claim 1, wherein the disc halves are manufactured as cast parts.

4. Filter/screening disc according to one of claim 1, wherein the disc halves are interlocked together.

5. Filter/screening disc according to claim 4, further comprising a bayonet catch mounting the second disc half to the first disc half.

6. Filter/screening disc according to claim 1, wherein the screen/filter element is mounted to the base structure by a weld.

7. Filter/screening disc according to claim 6, wherein the weld is an electron-beam weld, a laser weld, a TIG weld or solder.

8. Filter or screen according to claim 1, wherein the screen/filter element includes a plurality of clips, the screen/filter element being secured to the base structure with the clips.

9. Process for manufacturing a filter/screening disc for use with a membrane filter including a hollow shaft, the process including the steps of:
manufacturing a first disc half having a first portion of a hollow base structure and a first portion of a screen/filter element; and
manufacturing a second disc half having a second portion of a hollow base structure and a second portion of a screen/filter element;
wherein the first and second disc halves define the filter/screening disc.

10. Process according to claim 9, wherein the steps of manufacturing the disc halves comprise manufacturing the disc halves in a deep-drawing process.

11. Process according to claim 9, wherein the steps of manufacturing the disc halves comprise casting the disc halves.

12. Process according to claim 9, wherein the step of manufacturing the first disc half comprises welding the first portion of the screen/filter element to the first portion of the hollow base structure and the step of manufacturing the second disc half comprises welding the second portion of the screen/filter element to the second portion of the hollow base structure.

13. Process according to claim 9, further comprising the step of interlocking the disc halves together.

14. Process according to claim 9, further comprising the steps of:
sealing the disc halves to the hollow shaft and
securing the disc halves to the hollow shaft.
